(19) United States
(12) Patent Application Publication
(10) Pub. No.: US 2024/0386278 A1
(43) Pub. Date: Nov. 21, 2024

(54) METHOD AND DEVICE WITH CONTINUAL LEARNING

(71) Applicants: SAMSUNG ELECTRONICS CO., LTD., Suwon-si (KR); Seoul National University R&DB Foundation, Seoul (KR)

(72) Inventors: Hong Joon AHN, Seoul (KR); Jinu HYEON, Seoul (KR); Tae Sup MOON, Seoul (KR)

(73) Assignees: SAMSUNG ELECTRONICS CO., LTD., Suwon-si (KR); Seoul National University R&DB Foundation, Seoul (KR)

(21) Appl. No.: 18/663,969

(22) Filed: May 14, 2024

(30) Foreign Application Priority Data
May 15, 2023 (KR) 10-2023-0062655
Sep. 12, 2023 (KR) 10-2023-0121054

(51) Int. Cl. G06N 3/092; G06N 3/045

(52) U.S. Cl. CPC G06N 3/092; G06N 3/045

(57) ABSTRACT

A method and device for performing continual learning are provided. The method of performing continual learning of tasks in a set of tasks includes learning a first model based on training data corresponding to a current task in the set of tasks, learning a second model based on information on the current task and information on a previous learning task in the set of tasks, and resetting the first model.

### CROSS-REFERENCE TO RELATED APPLICATIONS

This application claims the benefit under 35 USC § 119 (a) of Korean Patent Application No. 10-2023-0062655, filed on May 15, 2023 and 10-2023-0121054 filed on Sep. 12, 2023, in the Korean Intellectual Property Office, the entire disclosures of which are incorporated herein by reference for all purposes.

### BACKGROUND

### 1. Field

The following description relates to a method and device with continual learning, and more particularly, to a method of resetting and distillation for continual reinforcement learning (CRL).

### 2. Description of Related Art

Continual learning technologies involve learning from a data stream with the goal of remembering previously learned knowledge and succeeding at a current task. Existing continual learning technologies often include task continual learning (TCL), in which data arrives sequentially in a task group. To mitigate the risk of catastrophic forgetting (CF), knowledge may be refined by adapting a model trained with new data and generalizing the new data by overwriting a weight of the trained model. Particularly, regularization-based, memory replay-based, and dynamic model-based continual learning methods may be considered as a strategy to mitigate the CF problem.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of performing continual learning of a plurality of tasks includes learning a first model based on training data corresponding to a current task in a set of tasks, learning a second model based on information on the current task and information on a previous learning task in the set of tasks, and resetting the first model.

The learning of the first model may include learning the first model based on a reinforcement learning algorithm.

The learning of the second model may include performing knowledge distillation from the first model to the second model and performing behavioral cloning (BC) of the second model based on the information on the previous learning task.

The method may further include storing the information on the current task in a first buffer and maintaining a second buffer including the information on the previous learning task.

The learning of the second model may include receiving the information on the current task from the first buffer and receiving the information on the previous learning task from the second buffer.

The method may further include, when the learning of the second model is completed, updating the second buffer based on the first buffer and resetting the first buffer.

The updating of the second buffer may include storing, in the second buffer, a portion of the information on the current task stored in the first buffer.

The learning of the second model may include determining a first loss function based on the information on the current task, determining a second loss function based on the information on the previous learning task, and learning the second model based on the first loss function and the second loss function.

In another general aspect, an inference method includes receiving input data and outputting a task, the task corresponding to the input data among tasks in a set of tasks, by inputting the input data to a continual learning model, wherein the continual learning model is trained based on a reinforcement learning model that is distinct from the continual learning model, and wherein the reinforcement learning model is reset each time learning of a task in the set of tasks is completed.

In another general aspect, an electronic device includes a memory configured to store at least one instruction and a processor configured to, by executing the instruction stored in the memory, learn a first model based on training data corresponding to a current task in a set of tasks, learn a second model based on information on the current task and information on a previous learning task in the set of tasks, and reset the first model.

The processor may be configured to learn the first model based on a reinforcement learning algorithm.

The processor may be configured to perform knowledge distillation from the first model to the second model and perform behavioral cloning (BC) of the second model based on the information on the previous learning task.

The processor may be configured to store the information on the current task in a first buffer and maintain a second buffer including the information on the previous learning task.

The processor may be configured to receive the information on the current task from the first buffer and receive the information on the previous learning task from the second buffer.

The processor may be configured to, when the learning of the second model is completed, update the second buffer based on the first buffer and reset the first buffer.

The processor may be configured to store, in the second buffer, a portion of the information on the current task stored in the first buffer.

The processor may be configured to determine a first loss function based on the information on the current task, determine a second loss function based on the information on the previous learning task, and perform the learning the second model based on the first loss function and the second loss function.

In another general aspect, an electronic device includes a memory configured to store at least one instruction and a processor configured to, by executing the instruction stored in the memory, receive input data and output a task, the task corresponding to the input data among tasks in a set of tasks, by inputting the input data to a continual learning model, wherein the continual learning model is trained based on a reinforcement learning model that is distinct from the continual learning model, and the reinforcement learning model is reset each time learning of a task in the set of tasks is completed.

Other features and aspects will be apparent from the following detailed description, the drawings, and the claims.

### BRIEF DESCRIPTION OF THE DRAWINGS

FIG. 1A illustrates an example of continual reinforcement learning (CRL) according to one or more embodiments.

FIG. 1B illustrates an example of negative transfer in CRL according to one or more embodiments.

FIG. 2A illustrates an example of a deep learning operation method using a neural network (NN) according to one or more embodiments.

FIG. 2B illustrates an example of a CRL system according to one or more embodiments.

FIGS. 3A to 3B illustrate a CRL method according to one or more embodiments.

FIG. 4 illustrates an example of a method of performing continual learning according to one or more embodiments.

FIG. 5 illustrates an example of an inference method according to one or more embodiments.

FIG. 6 illustrates an example of an inference method according to one or more embodiments.

FIGS. 7A and 7B each illustrate an example of the effect of a CRL method described herein, according to one or more embodiments.

FIG. 8 illustrates an example of a configuration of a training device according to one or more embodiments.

FIG. 9 illustrates an example of a configuration of an inference device according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

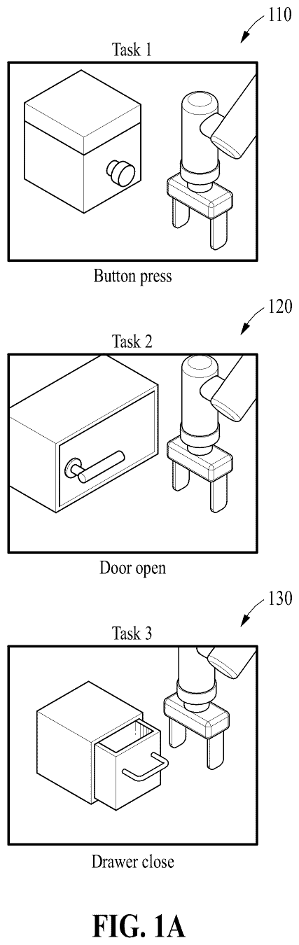

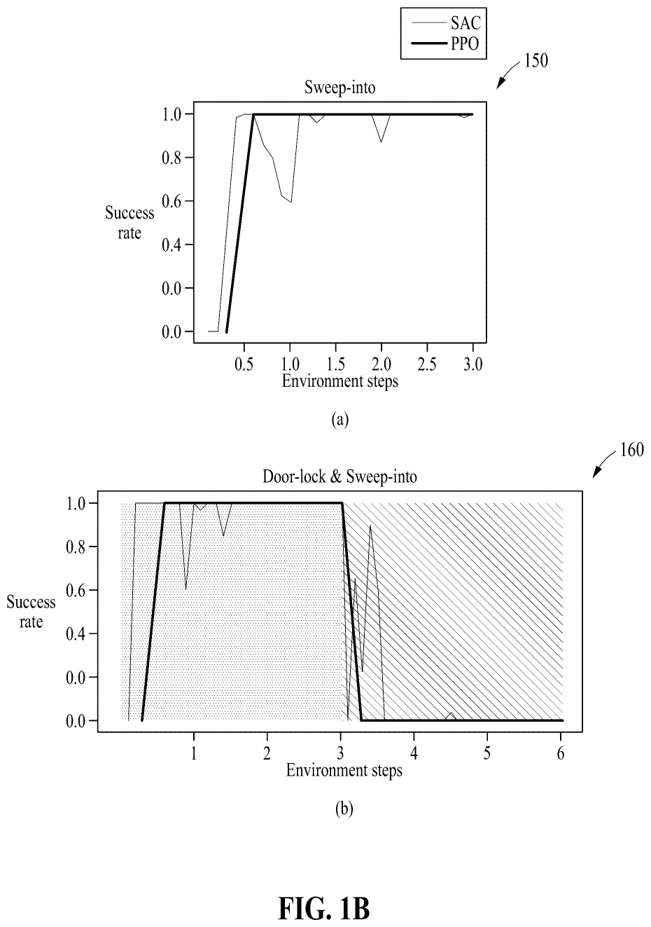

FIG. 1A illustrates an example of continual reinforcement learning (CRL) according to one or more embodiments.

Reinforcement learning is an area of machine learning and may include, as an example, a method in which an agent defined within an environment recognizes a current state and, according to the current state, selects, among selectable actions, an action or action sequence that maximizes a reward. Reinforcement learning differs from general supervised learning in that a training set of input-output pairs is not necessarily presented and correction does not necessarily explicitly occur for an incorrect behavior. Instead, the focus of reinforcement learning is on-line performance, which may be improved by balancing exploration and exploitation.

Recently, following the impressive success of reinforcement learning in various application fields, numerous studies have been conducted to improve the learning efficiency of a reinforcement learning algorithm, and CRL is one of the results of the studies. CRL aims to have an agent continually learn to improve a decision-making policy for multiple tasks.

CRL is a type of continual learning, which refers to a method in which a deep learning model continually learns based on new data. A general deep learning model learns from a large dataset and learns a generalized pattern based on the dataset. However, in a real environment, new data is continually generated, and the new data may significantly differ from existing data. Continual learning may continually learn new data and gradually expand the learned knowledge to solve the issues of existing deep learning (e.g., inability to adapt to new data). This is because it may be more efficient and economical to only add new data to an already learned model rather than retraining a model anew every time new data comes out.

Referring to FIG. 1A, CRL may be effective when learning tasks that arrive sequentially to an actor are similar to each other, such as in robot behavior learning. For example, a button pressing task (hereinafter, task 1) 110, a door opening task (hereinafter, task 2) 120, and a drawer closing task (hereinafter, task 3) 130 may be learned all at once through CRL. However, CRL has an issue in that catastrophic forgetting (CF) of previously learned knowledge may occur. For example, in task 1, a model may be trained so that a robot may perform a button pressing action. Subsequently, the trained model may be trained again so that the robot may perform a door opening action. Next, the trained model may be trained again so that the robot may perform the drawer closing action. The biggest problem of continually training new tasks on a previously trained model in this way is that the previously learned content may be forgotten (lost from the state of the trained model). After training the drawer closing task, the accuracy of the button pressing task that was learned first may decrease significantly. In other words, as the model is gradually trained, the previously learned content may be gradually forgotten.

CRL may have an issue of negative transfer as well as CF. Negative transfer in CRL refers to a phenomenon in which learning of a new task fails, even when fine-tuning is performed, due to intrusive information that is learned in a previous task (previous learning interferes with new learning). Negative transfer does not occur in general continual supervised learning and may only occur in CRL. Because, unlike supervised learning, which may always use a true label for a new task, an agent in reinforcement learning sometimes may not correctly modify a previously learned policy for a new task due to the lack of true labels and weak reward signals.

FIG. 1B illustrates an example of negative transfer in CRL, according to one or more embodiments.

Referring to FIG. 1B, a first diagram 150 illustrates the learning success rate (vertical axis) of a sweep task for three million steps (horizontal axis) using the Soft Actor-Critic (SAC) algorithm and the Proximal Policy Optimization (PPO) algorithm, which are examples of reinforcement learning algorithms. However, the reinforcement learning algorithm is not limited to the SAC and PPO algorithms. Referring to the first diagram 150, both the algorithms quickly achieve a success rate of 1, and from this it is apparent that the sweep task is an easy task to learn from the beginning.

A second diagram 160 illustrates the learning success rate when a three million-step door locking task is first learned and a three million-step sweep task is subsequently learned using the SAC algorithm and the PPO algorithm. Referring to the second diagram 160, it is apparent that the success rate of the sweep task converges to 0, which indicates that negative transfer occurs in the CRL.

As described in detail below, in performing CRL, a model may be reset each time a task is learned in order to prevent negative transfer. However, since CF may occur when a model is intentionally reset, knowledge distillation (KD) may be performed on a continual learning model in the method of performing CRL.

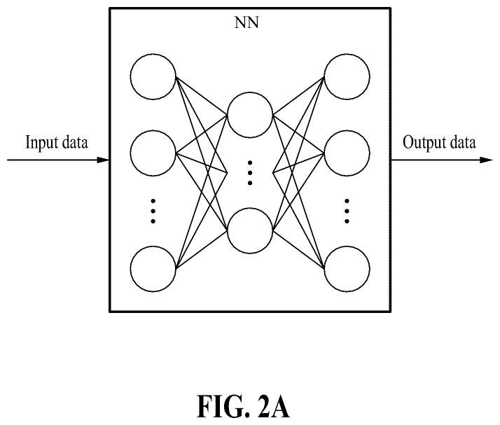

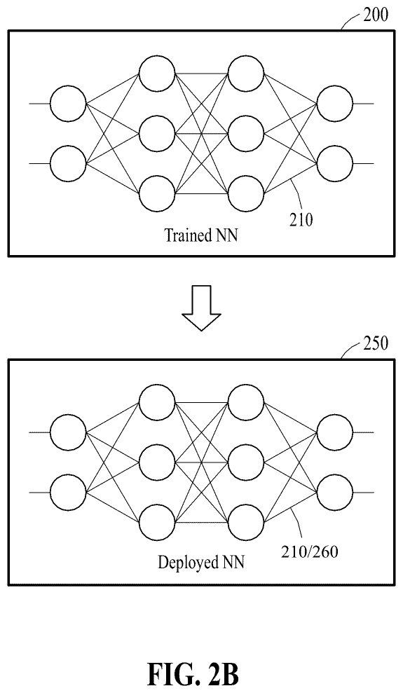

FIG. 2A illustrates an example of a deep learning operation method using an artificial neural network (NN), according to one or more embodiments.

An artificial intelligence (Al) algorithm including deep learning may input data to an NN, train the NN with output data through operations such as convolution, and extract features using the trained NN. The NN may be a computational element with a network architecture. In the NN, nodes are connected to each other and collectively operate to process the input data. Various types of neural networks include, for example, a convolutional neural network (CNN), a recurrent neural network (RNN), a deep belief network (DBN), and a restricted Boltzmann machine (RBM) model. However, examples are not limited thereto. In a feed-forward neural network, nodes have links to other nodes. The links may expand in one direction, for example, a forward direction, through a neural network. A NN model may have an input layer, hidden layers, and an output layer. Each layer may be made of nodes. There may be connections or links between the nodes of a layer and the nodes of a following layer. The NN model may map inputs at the input layer based on weights of the nodes, among other things.

FIG. 2A illustrates a structure of an NN (e.g., a CNN) for receiving input data and outputting output data. The NN may be a deep neural network including at least two layers.

FIG. 2B illustrates an example of a CRL system, according to one or more embodiments.

Referring to FIG. 2B, the CRL system may include a training device 200 and an inference device 250. The training device 200 may correspond to a computing device having various processing functions such as generating a neural network, training (or learning) a neural network, or retraining a neural network. For example, the training device 200 may be implemented as various types of devices such as a PC, a server device, a mobile device, and the like.

The training device 200 may generate a trained neural network 210 by repetitively training (or learning) a given initial neural network. The generating of the trained neural network 210 may involve determining neural network parameters. I neural network parameters may include various types of data, for example, input/output activations, weights, and biases, any of which may be changed by training of the trained neural network 210. When the neural network 210 is repeatedly trained, the parameters of the neural network 210 may be tuned to calculate a more accurate output for a given input.

The training device 200 may transmit the at least one trained neural network 210 to the inference device 250. The inference device 250 may be, for example, a mobile device or an embedded device. The inference device 250 may be dedicated hardware for driving a neural network and may be an electronic device including at least one of a processor, memory, an input/output (I/O) interface, a display, a communication interface, or a sensor. For example, the sensor may include one or more cameras or other imaging sensors to capture images of scenes. To summarize, training of the neural network 210 and use of the neural network (performing inferences) may be performed on respective different computing devices.

The inference device 250 may be any digital device that includes a memory element and a microprocessor and has an operational capability, such as a tablet PC, a smartphone, a PC (e.g., a notebook computer), an Al speaker, a smart TV, a mobile phone, a navigation, a web pad, a personal digital assistant (PDA), a workstation, and the like.

The inference device 250 may drive (execute) the at least one trained neural network 210 without a change thereto or may drive a neural network 260 obtained by processing (for example, quantizing) the at least one trained neural network 210. The inference device 250 for driving the neural network 210/260 may be implemented in a separate device independent of the training device 200. However, examples are not limited thereto. The inference device 250 may also be implemented in the same device as the training device 200.

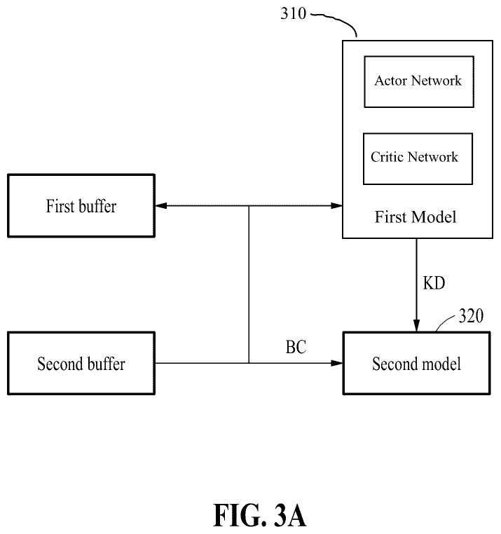

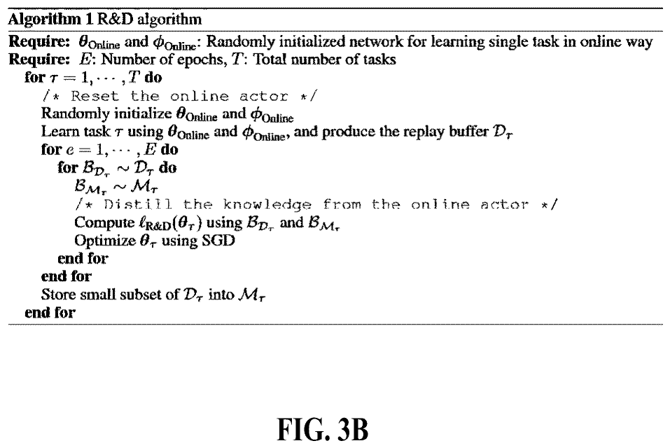

FIGS. 3A to 3B illustrate a CRL method, according to one or more embodiments.

Referring to FIG. 3A, a training device (e.g., the training device 200 of FIG. 2B) may perform continual learning of multiple tasks. The training device may learn a NN model, and the NN model may include a first model 310 and a second model 320.

The first model 310 may be a reinforcement learning-based neural network. For example, the first model 310 may be learned according to an actor-critic architecture. In this case, the first model 310 may include an actor network that learns a policy and a critic network that learns a value function. The critic may evaluate a policy (useable to perform actions) by estimating the values of respective state-action pairs in the policy, while the actor may improve the policy by maximizing an expected reward.

The second model 320 is a neural network that receives knowledge distillation (KD) from the first model 310. The first model 310 may be referred to as a teacher model and the second model 320 may be referred to as a student model in that the first model 310 performs knowledge distillation on the second model 320. Alternatively, the first model 310 may be referred to as an online model in that the first model 310 learns a new task in an online way by interacting with an environment, and the second model 320 may be referred to as an offline model in that the second model 320 replicates a behavior of the online model in an offline way without interacting with the environment. Alternatively, the first model 310 may be referred to as a single task model and the second model 320 may be referred to as a continual model. The training device may perform CRL without (or with minimalized) CF and negative transfer using the first model 310 and the second model 320.

More specifically, the first model 310 may learn a current task T according to a reinforcement learning algorithm and store information on the current task T (e.g., state of the first model 310) in a replay buffer DT. Subsequently, the first model 310 may distill knowledge about the current task T to the second model 320 using state information stored in the replay buffer DT. Hereinafter, the replay buffer DT may be referred to as a first buffer.

The second model 320 (θ_{T}), to prevent CF in a distillation process thereof, may use an expert buffer MT. The expert buffer MT may include information on a previous task (previous relative to a current task). After the distillation process, the first model 310 may be reset to learn a next task from the beginning. The above-described learning algorithm may be referred to as a Reset and Distill (R&D) algorithm and as illustrated in FIG. 3B.

When the actor θ_{T} of the second model 320 replicates a behavior of an actor of the first model 310 in the current task T, the loss function of Equation 1 below may be used to compute lost.

$${ℓ}_{R \& D} ( {θ}_{τ} ) = {\underbrace{{\sum }_{( {s}_{t} , {a}_{t} , {r}_{t} , {s}_{t + 1} ) ∈ {ℬ}_{{𝒟}_{τ}}} KL ( π ( \cdot \vert {s}_{t} ; {θ}_{Online} ) ‖ π ( \cdot \vert {s}_{t} ; {θ}_{τ} ) )}}_{( a )} + {\underbrace{{\sum }_{( {s}_{t} , π ( \cdot \vert {s}_{t} ; {θ}_{k} ) ) ∈ {ℬ}_{{ℳ}_{τ}}} KL ( π ( \cdot \vert {s}_{t} ; {θ}_{τ} ) ‖ π ( \cdot \vert {s}_{t} ; {θ}_{k} ) )}}_{( b )} , \qquad Equation 1$$

In Equation 1, [symbol] and [symbol] respectively mini-batches sampled from D_{T} and M_{T}, respectively. The term θₒₙₗᵢₙₑ denotes an actor network parameter of the first model 310, s, and a_{T} denote the set of all possible states and actions for the task _{T}, π(Sₜ, aₜ) denotes a reward function that generates a scalar value at each transition, KL denotes Kullback-Leibler (KL) divergence, and k denotes the previous task.

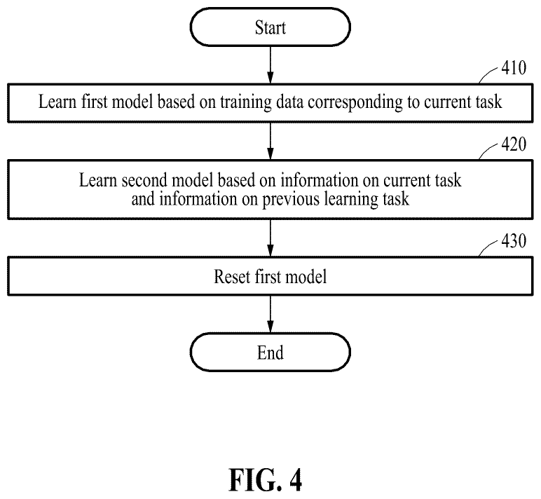

FIG. 4 illustrates an example of a method of performing continual learning, according to one or more embodiments. The description provided with reference to FIGS. 1A to 3B may also apply to FIG. 4.

For ease of description, operations 410 to 430 are described as being performed using the training device 200 shown in FIG. 2B. However, operations 410 to 430 may be performed by another suitable electronic device in any suitable system.

Referring to FIG. 4, in operation 410, a training device may learn a first model based on training data corresponding to a current task. The training data may be specific to training/learning for the current task. The training device may learn the first model based on a reinforcement learning algorithm as applied to the current training data.

In operation 420, the training device may learn a second model based on information on the current task and information on a previous learning task. The training device may perform knowledge distillation from the first model to the second model and may perform behavioral cloning (BC) of the second model based on the information on the previous learning task.

The training device may store the information on the current task in a first buffer and maintain a second buffer including information on the previous learning task. The training device may receive the information on the current task from the first buffer and receive the information on the previous learning task from the second buffer.

When learning of the second model is completed, the training device may update the second buffer based on the first buffer and then reset the first buffer. The training device may store, in the second buffer, a portion of the information on the current task stored in the first buffer.

The training device may determine a first loss function based on the information on the current task, determine a second loss function based on the information on the previous learning task, and learn the second model based on the first loss function and the second loss function.

In operation 430, the training device may reset the first model. Resetting may involve, for example, an operation of randomly initializing a parameter of the model.

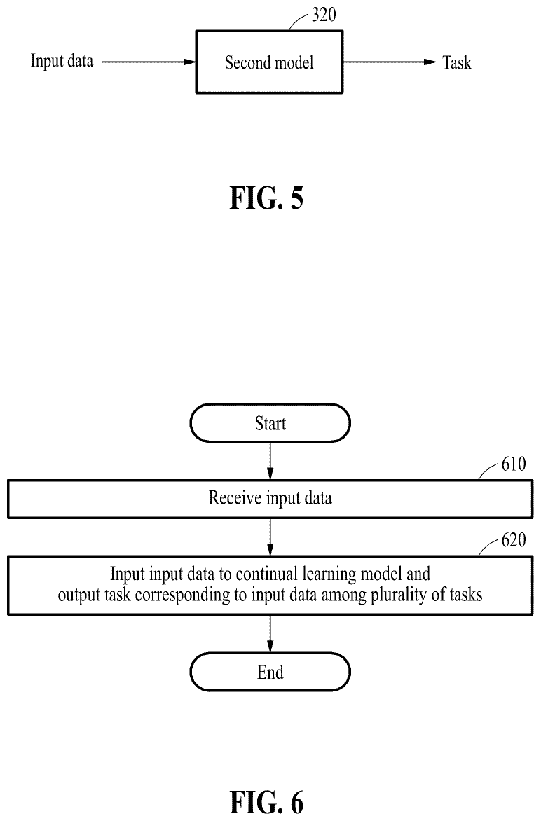

FIG. 5 illustrates an example of an inference method, according to one or more embodiments.

Referring to FIG. 5, an inference device (e.g., the inference device 250 of FIG. 2B) may output a task corresponding to input data using a learned NN model.

More specifically, the inference device may receive input data (e.g., a door locking command) and input the input data to a second model (e.g., the second model 320 of FIG. 3A) of a learned NN model. The second model 320 may output a task corresponding to the input data among a plurality of tasks. Since the second model 320 is trained based on the R&D algorithm, negative transfer and CF phenomena may not occur (or may be minimalized), and accordingly, an accurate task suitable for the input data may be output.

FIG. 6 illustrates an example of an inference method, according to one or more embodiments. The description provided with reference to FIG. 5 also generally apples to FIG. 6.

For ease of description, it is described that operations 610 and 620 are performed using the inference device 250 shown in FIG. 2B. However, operations 610 and 620 may be performed by another suitable electronic device in any suitable system.

Referring to FIG. 6, in operation 610, an inference device may receive input data.

In operation 620, the inference device may input the input data to a continual learning model and output a task corresponding to the input data among a plurality of tasks. More specifically, the inference device may input the input data to a second model (e.g., the second model 320 of FIG. 3A) of a learned NN model.

The continual learning model may be trained based on a reinforcement learning model that is distinct from the continual learning model, and the reinforcement learning model may be reset each time learning of each of the plurality of tasks is completed.

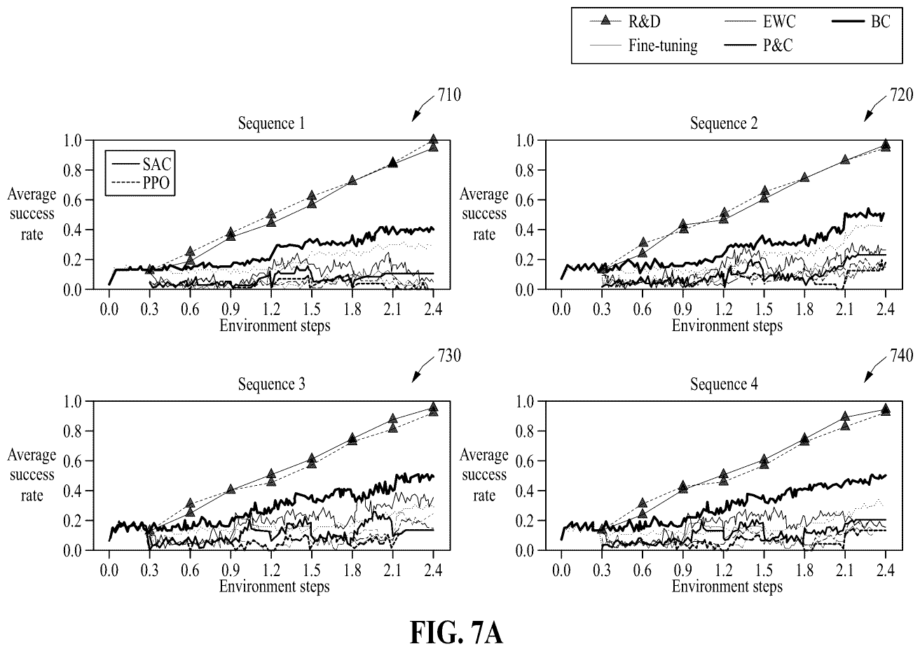

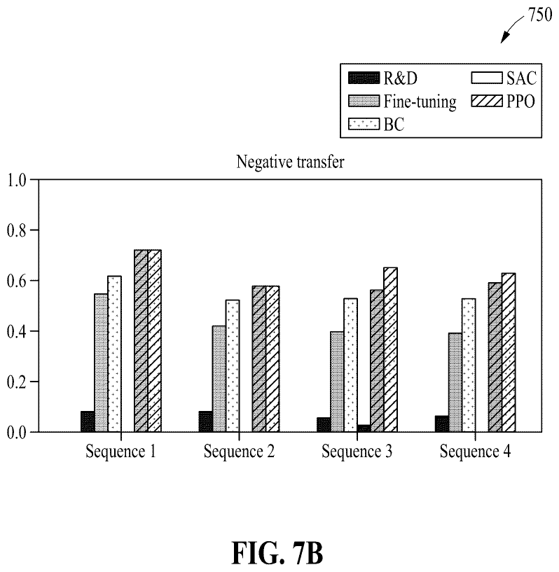

FIGS. 7A and 7B each illustrate an example effect of a CRL method described herein, according to one or more embodiments.

Referring to FIG. 7A, graphs 710 to 740 illustrate the average success rate of various methods for four types of task sequences learned using the SAC algorithm (solid line) and the PPO algorithm (dashed line). Other methods are represented by lines that are below the dashed and dotted lines of the SAC and PPO algorithms (with the R&D algorithm). Note that the “EWC” in FIG. 7A stands for “elastic weight consolidation”.

Referring to the graphs 710 to 740, it may be seen that in all four types of task sequences, the performance of the R&D algorithm is significantly higher than that of other methods. Furthermore, the average success rate of the R&D algorithm approaches closely to “1,” which indicates that the R&D algorithm may be successfully overcoming both CF and negative transfer.

Referring to FIG. 7B, a graph 750 illustrates the results of measuring negative transfer of three different methods in four types of sequences. Referring to the graph 750, it may be seen that the R&D algorithm has a much lower degree of negative transfer than other methods.

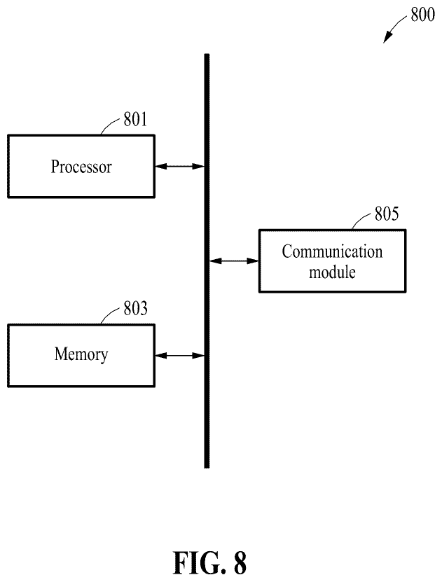

FIG. 8 illustrates an example of a configuration of a training device 800, according to one or more embodiments.

Referring to FIG. 8, the training device 800 may include a processor 801, a memory 803, and a communication module 805. In practice, the processor 801 may be multiple processors.

The processor 801 may perform at least one of the operations described above with reference to FIGS. 1A to 4. The processor 801 may learn a first model based on training data corresponding to a current task, learn a second model based on information on the current task and information on the previous learning task, and reset the first model.

The memory 803 may be a volatile memory or a non-volatile memory, and the memory 803 may store data needed to perform CRL. The memory 803 may include a first buffer and a second buffer.

The communication module 805 may provide a function for the training device 800 to communicate with another electronic device or another server through a network. In other words, the training device 800 may be connected to an external device through the communication module 805 and exchange data with the external device.

The training device 800 may further include components not shown in drawings. For example, the training device 800 may further include an I/O interface including an input device and an output device as the means of interfacing with the communication module 805. In addition, for example, the training device 800 may further include other components such as a transceiver, various sensors, a database, and the like.

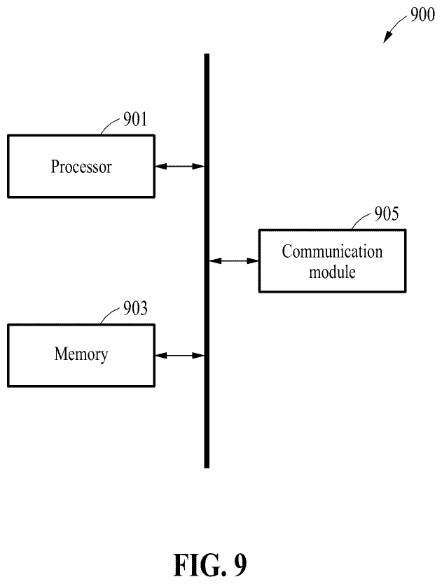

FIG. 9 illustrates an example of a configuration of an inference device 900. according to one or more embodiments.

Referring to FIG. 9, the inference device 900 may include a processor 901, a memory 903, and a communication module 905.

The processor 901 may perform at least one of the operations described above with reference to FIGS. 1A to 4. The processor 901 may receive input data, input the input data to a continual learning model, and output a task corresponding to the input data among a plurality of tasks.

The memory 903 may be a volatile memory or a non-volatile memory, and the memory 903 may store data (e.g., a parameter of a trained second model) needed to perform an inference operation. The memory 903 may include a first buffer and a second buffer.

The communication module 905 may provide a function for the inference device 900 to communicate with another electronic device or another server through a network. In other words, the inference device 900 may be connected to an external device through the communication module 905 and exchange data with the external device.

The inference device 900 may further include components not shown in drawings. For example, the inference device 900 may further include an I/O interface including an input device and an output device as the means of interfacing with the communication module 905. In addition, for example, the inference device 900 may further include other components such as a transceiver, various sensors, a database, and the like.

The R&D algorithm is described in part with mathematical notation. However, the mathematical notation is a convenient shorthand (or “language”) for describing the operations of physical computing devices. With the description herein of the R&D algorithm (including mathematical notation), one may readily use tools (e.g., software and/or circuit engineering tools) to implement the R&D algorithm, and it is those physical device implementations of the R&D algorithm to which this disclosure is directed, whether in the form of specially constructed integrated circuits, processor(s) in combination with memory storing instructions that implement the R&D algorithm, or combinations thereof. Moreover, such physical devices configured to implement the R&D algorithm can be used to better control the actions thereof (or of another device) in order to perform physical tasks, for example, such as moving a robot, controlling movement of a robotic arm, and so forth. Such robotic control is just one example of an application of the R&D algorithm.

The computing apparatuses, the electronic devices, the processors, the memories, the displays, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed:

1. A method of performing continual learning of a plurality of tasks, wherein the method is performed by one or more processors executing instructions from a memory that are configured to cause the one or more processors to perform the method, the method comprising:
learning a first model based on training data corresponding to a current task in a set of tasks;
learning a second model based on information on the current task and information on a previous learning task in the set of tasks; and
resetting the first model.

2. The method of claim 1, wherein the learning of the first model is based on a reinforcement learning algorithm.

3. The method of claim 1, wherein the learning of the second model comprises:
performing knowledge distillation from the first model to the second model; and
performing behavioral cloning (BC) of the second model based on the information on the previous learning task.

4. The method of claim 1, further comprising:
storing the information on the current task in a first buffer; and
maintaining a second buffer comprising the information on the previous learning task.

5. The method of claim 4, wherein the learning of the second model comprises:
receiving the information on the current task from the first buffer; and
receiving the information on the previous learning task from the second buffer.

6. The method of claim 5, further comprising, when the learning of the second model is completed:
updating the second buffer based on the first buffer; and
resetting the first buffer.

7. The method of claim 6, wherein the updating of the second buffer comprises:
storing, in the second buffer, a portion of the information on the current task stored in the first buffer.

8. The method of claim 1, wherein the learning of the second model comprises:
determining a first loss function based on the information on the current task;
determining a second loss function based on the information on the previous learning task; and
performing the learning of the second model based on the first loss function and the second loss function.

9. An inference method performed by one or more processors executing instructions configured to cause the one or more processors to perform the method, the method comprising:
receiving input data; and
outputting a task, the task corresponding to the input data among tasks in a set of tasks, by inputting the input data to a continual learning model,
wherein the continual learning model is trained based on a reinforcement learning model that is distinct from the continual learning model, and wherein the reinforcement learning model is reset each time learning of a task in the set of tasks is completed.

10. A non-transitory computer-readable storage medium storing instructions that, when executed by a processor, cause the processor to perform the method of claim 1.

11. An electronic device comprising:
one or more processors; and
a memory storing instructions configured to cause the one or more processors to:
learn a first model based on training data corresponding to a current task in a set of tasks;
learn a second model based on information on the current task and information on a previous learning task in the set of tasks; and
reset the first model.

12. The electronic device of claim 11, wherein the instructions are further configured to cause the one or more processors to learn the first model based on a reinforcement learning algorithm.

13. The electronic device of claim 11, wherein the instructions are further configured to cause the one or more processors to:
perform knowledge distillation from the first model to the second model; and
perform behavioral cloning (BC) of the second model based on the information on the previous learning task.

14. The electronic device of claim 11, wherein the instructions are further configured to cause the one or more processors to:
store the information on the current task in a first buffer; and
maintain a second buffer comprising the information on the previous learning task.

15. The electronic device of claim 14, wherein the instructions are further configured to cause the one or more processors to:
receive the information on the current task from the first buffer; and
receive the information on the previous learning task from the second buffer.

16. The electronic device of claim 15, wherein the instructions are further configured to cause the one or more processors to, when the learning of the second model is completed:
update the second buffer based on the first buffer; and
reset the first buffer.

17. The electronic device of claim 16, wherein the instructions are further configured to cause the one or more processors to:
store, in the second buffer, a portion of the information on the current task stored in the first buffer.

18. The electronic device of claim 11, wherein the instructions are further configured to cause the one or more processors to:
determine a first loss function based on the information on the current task;
determine a second loss function based on the information on the previous learning task; and
perform the learning of the second model based on the first loss function and the second loss function.

19. An electronic device comprising:
one or more processors; and
a memory configured storing instructions configured to cause the one or more processors to:
receive input data; and
output a task, the task corresponding to the input data among a set of tasks, by inputting the input data to a continual learning model,
wherein the continual learning model is trained based on a reinforcement learning model that is distinct from the continual learning model, and the reinforcement learning model is reset each time learning of a task in the set of tasks is completed.
